(19) United States
(12) Patent Application Publication
(10) Pub. No.: US 2011/0062289 A1
(43) Pub. Date: Mar. 17, 2011

(54) Envelope With Gas Management System For Lighter-Than-Air Aircraft

(76) Inventor: Adam N. Chu, Colorado Springs, CO (US)

(21) Appl. No.: 12/559,113

(22) Filed: Sep. 14, 2009

(51) Int. Cl. B64B 1/62

(52) U.S. Cl. 244/34 R

(57) ABSTRACT

An envelope holds gas in a lighter-than-air aircraft. The envelope has an outer shell, an inner wall, a compressor, and a valve. The outer shell has an upper surface, a lower surface, a leading edge, a trailing edge, opposing side surfaces, and an airfoil-shaped lateral cross-section. The inner wall divides the outer shell into high and low pressure chambers. The compressor is disposed between the high and low pressure chambers and controlled to selectively force gas from the low pressure chamber to flow into the high pressure chamber. The valve is disposed between the high pressure chamber and the low pressure chamber and controlled to selectively permit gas from the high pressure chamber to flow into the low pressure chamber.

### BACKGROUND OF THE INVENTION

Lighter-than-air aircraft take many forms and have a variety of uses. Primary uses for unmanned high altitude lighter-than-air aircraft are for surveillance and communications. Often, it is desirable that these aircraft maintain their position, or station keep.

Traditionally, these high altitude aircraft fly below 70,000 feet. It would be greatly advantageous to fly above 70,000 feet to be above atmospheric turbulence and disruptive weather, and to deconflict from commercial, private, and military fixed wing aircraft. However, at altitudes above 70,000 feet, strong winds are present. In order to station keep in these strong winds, it is highly useful for the aircraft to have a low aerodynamic drag.

### DESCRIPTION OF THE DRAWINGS

FIG. 1 is a perspective view of the envelope of the present invention.

FIG. 2 is a side elevation of the envelope of the present invention.

FIG. 3 is a top elevation of the envelope of the present invention.

FIG. 4 is a front elevation of the envelope of the present invention.

FIG. 5 is a longitudinal cross-section of the envelope of the present invention illustrating the high and low pressure chambers.

FIG. 6 is an exploded view of the longitudinal cross-section of FIG. 5.

### DETAILED DESCRIPTION OF THE INVENTION

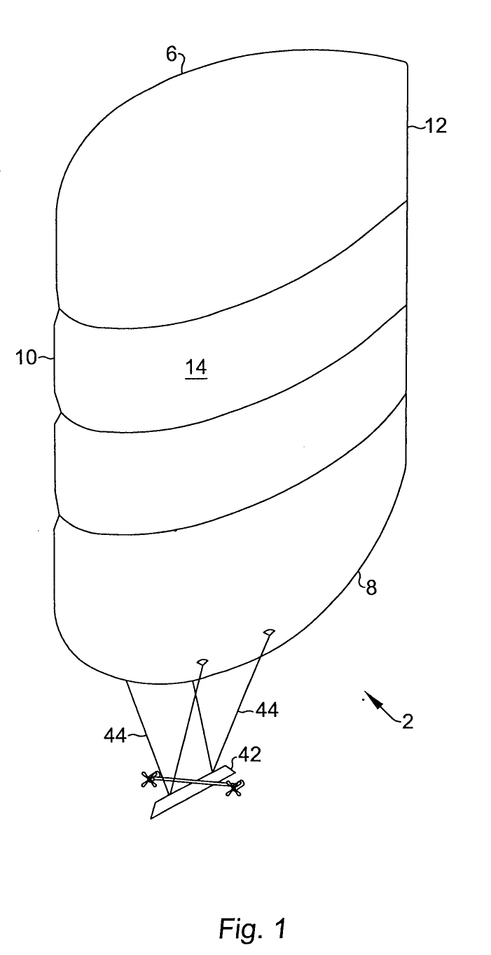

FIGS. 1-4 illustrates envelope 2 for holding gas in a lighter-than-air aircraft. A payload 42 is supported by envelope 2. Tethers 44 attach payload 42 to envelope 2.

Envelope 2 includes an outer shell 4. Outer shell 4 has an upper surface 6, a lower surface 8, a leading edge 10, a trailing edge 12, and opposing side surfaces 14, 16. In one embodiment, outer shell 4 is symmetrical about a plane defined by leading edge 10 and trailing edge 12.

Leading edge 10 and trailing edge 12 are each disposed between upper 6 and lower 8 surfaces. Opposing side surfaces 14, 16 extend between leading 10 and trailing 12 edges and upper 6 and lower 8 surfaces.

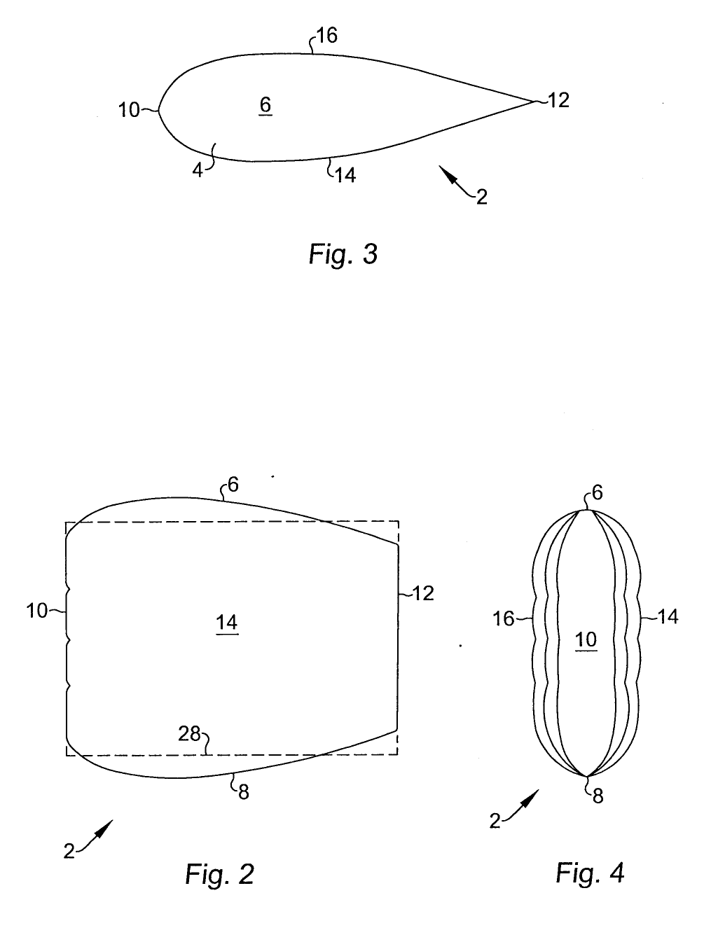

As may best be seen in FIG. 3, outer shell 4 also has an airfoil-shaped lateral cross-section. Also best seen in FIG. 3, in one embodiment, side surfaces 14, 16 are generally rectangular in shape. The generally rectangular shape may be truly rectangular or, alternatively, deviate from truly rectangular by extending beyond the boundaries of a perfect rectangle, as best seen in FIG. 2. The dashed lines represent the boundaries of a true rectangle 28. It can be seen that, although the boundaries of shell 4 do not exactly match the boundaries of the true rectangle 28, the boundaries are substantially close.

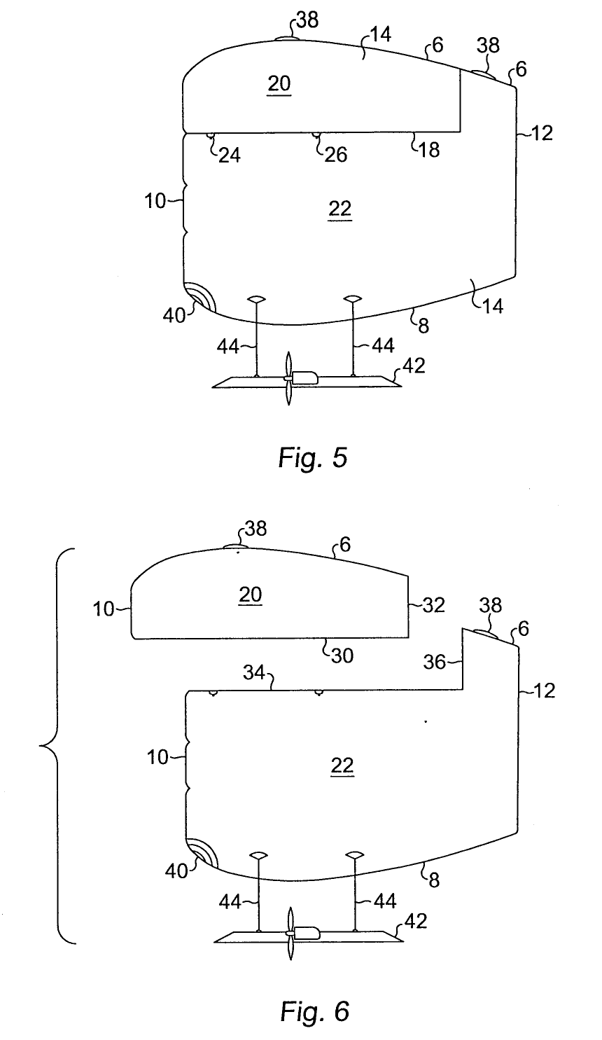

FIG. 5 is a longitudinal cross-section of envelope 2. In one embodiment, envelope 2 further includes an inner wall 18. Inner wall 18 divides outer shell 4 into a high pressure chamber 20 and a low pressure chamber 22. High pressure chamber 20 is disposed adjacent a portion of leading edge 10, upper surface 6, and side walls 14, 16. Low pressure chamber 22 is disposed adjacent trailing edge 12, bottom surface 8, a portion of leading edge 10, upper surface 6, and side walls 14, 16.

In one embodiment, high pressure chamber 20 is disposed adjacent at least 50 percent of upper surface 6 and low pressure chamber 22 is disposed adjacent no more than 50 percent of upper surface 6. In an alternative embodiment, high pressure chamber 20 is disposed adjacent at least 75 percent of upper surface 6 and low pressure chamber 22 is disposed adjacent no more than 25 percent of upper surface 6.

In one embodiment, low pressure chamber 22 is disposed adjacent at least 50 percent of leading edge 10 and high pressure chamber 20 is disposed adjacent no more than 50 percent of leading edge 10. In an alternative embodiment, low pressure chamber 22 is disposed adjacent at least 75 percent of leading edge 10 and high pressure chamber 20 is disposed adjacent no more than 25 percent of leading edge 10.

In one embodiment, envelope 2 further includes a compressor 24 disposed between high pressure chamber 20 and low pressure chamber 22. Compressor 24 is controlled to selectively force gas from low pressure chamber 22 to flow into high pressure chamber 20. Although only one compressor 24 is illustrated, any number of compressors 24 may be used.

In one embodiment, envelope 2 further includes a valve 26 disposed between high pressure chamber 20 and low pressure chamber 22. Valve 26 is controlled to selectively permit gas from high pressure chamber 20 to flow into low pressure chamber 22. Although only one valve 26 is illustrated, any number of valves 26 may be used.

FIG. 6 illustrates an exploded cross-section of envelope 2. In this illustration, envelope 2 includes high pressure chamber 20, low pressure chamber 22, compressor 24, valve 26, and an airfoil-shaped lateral cross-section (FIG. 3).

High pressure chamber 20 has upper surface 6, a lower interface 30, a rear interface 32, leading edge 10, and opposing side surfaces 14, 16. Opposing side surfaces 14, 16 are bounded by upper surface 6, lower interface 30, leading edge 10, and rear interface 32. In one embodiment, side surfaces 14, 16 of the high 20 and low 22 pressure chambers are together generally rectangular in shape.

Low pressure chamber 22 has upper surface 6, lower surface 8, leading edge 10, trailing edge 12, an upper interface 34, a front interface 36, and opposing side surfaces 14, 16. Opposing side surfaces 14, 16 are bounded by lower surface 8, upper surface 6, upper interface 34, leading edge 10, trailing edge 12, and front interface 36.

Upper surfaces 6 of high 20 and low 22 pressure chambers are contiguous. Lower interface 30 and upper interface 34 are integral. Rear interface 32 and front interface 36 are also integral. All of which are best illustrated in FIG. 5.

The relative sizes of the high pressure 20 and low pressure 22 chambers is significant, but may be adjusted depending on the desired result. In one embodiment, upper surface 6 of high pressure chamber 20 is at least as large as upper surface 6 of low pressure chamber 22. Alternatively, upper surface 6 of high pressure chamber 20 is at least three times as large as upper surface 6 of low pressure chamber 22. In one embodiment, leading edge 10 of low pressure chamber 22 is at least as large as leading edge 10 of high pressure chamber 20. Alternatively, leading edge 10 of low pressure chamber 22 is at least three times as large as leading edge 10 of high pressure chamber 20.

In one embodiment, envelope 2 further includes vent valves 38. Vent valves 38 allow gas to be exhausted from the high 20 and low 22 pressure chambers.

In addition, envelope 2 may further include a ram air duct 40. Ram air duct 40 allows ambient air to be forced into low pressure chamber 22. Ram air duct 40 may be further supplemented by a blower (not shown).

In one embodiment of using envelope 2, only high pressure chamber 20 is inflated for launch. As envelope 2 ascends, expanding gas from high pressure chamber 20 fills low pressure chamber 22. On station, a gas management system controls compressor 24 and valve 26 to manage the pressure and accommodate gas loss. As envelope 2 descends, gas is vented through vent valves 38 and ambient air is injected through ram air duct 40.

The foregoing description is only illustrative of the invention. Various alternatives, modifications, and variances can be devised by those skilled in the art without departing from the invention. Accordingly, the present invention embraces all such alternatives, modifications, and variances that fall within the scope of the described invention.

What is claimed is:

1. An envelope for holding gas in a lighter-than-air aircraft, the envelope comprising:
an outer shell having an upper surface, a lower surface, a leading edge between the upper and lower surfaces, a trailing edge between the upper and lower surfaces, opposing side surfaces extending between the leading and trailing edges and upper and lower surfaces, and an airfoil-shaped lateral cross-section;
an inner wall dividing the outer shell into a high pressure chamber and a low pressure chamber, the high pressure chamber disposed adjacent a portion of the leading edge, the upper surface, and the side walls of the outer shell, the low pressure chamber disposed adjacent the trailing edge, the bottom surface, and a portion of the leading edge, the upper surface, and the side walls of the outer shell;
a compressor disposed between the high pressure chamber and the low pressure chamber and controlled to selectively force gas from the low pressure chamber to flow into the high pressure chamber; and
a valve disposed between the high pressure chamber and the low pressure chamber and controlled to selectively permit gas from the high pressure chamber to flow into the low pressure chamber.

2. The envelope of claim 1 wherein the outer shell is symmetrical about a plane defined by the leading edge and the trailing edge.

3. The envelope of claim 1 wherein the high pressure chamber is disposed adjacent at least 50 percent of the upper surface.

4. The envelope of claim 3 wherein the low pressure chamber is disposed adjacent no more than 50 percent of the upper surface.

5. The envelope of claim 1 wherein the high pressure chamber is disposed adjacent at least 75 percent of the upper surface.

6. The envelope of claim 5 wherein the low pressure chamber is disposed adjacent no more than 25 percent of the upper surface.

7. The envelope of claim 1 wherein the low pressure chamber is disposed adjacent at least 50 percent of the leading edge.

8. The envelope of claim 7 wherein the high pressure chamber is disposed adjacent no more than 50 percent of the leading edge.

9. The envelope of claim 1 wherein the low pressure chamber is disposed adjacent at least 75 percent of the leading edge.

10. The envelope of claim 9 wherein the high pressure chamber is disposed adjacent no more than 25 percent of the leading edge.

11. The envelope of claim 1 wherein the side surfaces are generally rectangular in shape.

12. An envelope for holding gas in a lighter-than-air aircraft, the envelope comprising:
a high pressure chamber having an upper surface, a lower interface, a rear interface, a leading edge, and opposing side surfaces bounded by the upper surface, lower interface, leading edge, and rear interface;
a low pressure chamber having an upper surface, a lower surface, a leading edge, a trailing edge, an upper interface, a front interface, and opposing side surfaces bounded by the lower surface, upper surface, upper interface, leading edge, trailing edge, and front interface;
wherein the upper surfaces of the high and low pressure chambers are contiguous, the lower interface and upper interface are integral, and the rear interface and front interface are integral;
an airfoil-shaped lateral cross-section;
a compressor disposed between the high pressure chamber and the low pressure chamber and controlled to selectively force gas from the low pressure chamber to flow into the high pressure chamber; and
a valve disposed between the high pressure chamber and the low pressure chamber and controlled to selectively permit gas from the high pressure chamber to flow into the low pressure chamber.

13. The envelope of claim 12 wherein the upper surface of the high pressure chamber is at least as large as the upper surface of the low pressure chamber.

14. The envelope of claim 12 wherein the upper surface of the high pressure chamber is at least three times as large as the upper surface of the low pressure chamber.

15. The envelope of claim 12 wherein the leading edge of the low pressure chamber is at least as large as the leading edge of the high pressure chamber.

16. The envelope of claim 12 wherein the leading edge of the low pressure chamber is at least three times as large as the leading edge of the high pressure chamber.

17. The envelope of claim 12 wherein the side surfaces of the high and low pressure chambers are together generally rectangular in shape.
